(19) United States
(12) Patent Application Publication
(10) Pub. No.: US 2024/0411809 A1
(43) Pub. Date: Dec. 12, 2024

(54) System and Methods to Cover the Continuum of Real-time Decision-Making using a Distributed AI-Driven Search Engine on Visual Internet-of-Things

(71) Applicant: Board of Regents, The University of Texas System, Austin, TX (US)

(72) Inventors: Peyman Najafirad, San Antonio, TX (US); Arun Das, Pittsburgh, PA (US)

(21) Appl. No.: 18/736,011

(22) Filed: Jun. 6, 2024

Related U.S. Application Data
(60) Provisional application No. 63/506,532, filed on Jun. 6, 2023.

(51) Int. Cl. G06F 16/783; G06V 20/40

(52) U.S. Cl. CPC G06F 16/7837; G06V 20/46

(57) ABSTRACT

System, methods, and algorithms are disclosed to carry out real-time video scene parsing and indexing in conjunction with query-based retrieval of geographically distributed object-attribute relationships. A distributed video analytics query mechanism is disclosed that involves swarms of small deep neural networks at embedded-AI edge devices, which can quickly perform initial feature detection and extraction and also re-identification of features or object in a cooperative manner. Then, the high-volume edge inference may fall back to the query computing model in a cloud, which performs complementary large scale up processing and result generation. The final decision, labelling, and scene investigation may be done by humans after interpreting the query results. This approach can provide the benefit of low communication costs (edge to cloud) compared to continually offloading parallel streams of edge devices, such as video, to the cloud.

### PRIORITY CLAIM

This application claims the benefit of priority to U.S. Patent Application Ser. No. 63/506,532, filed Jun. 6, 2023, entitled “System and Methods to Cover the Continuum of Real-time Decision-Making using a Distributed AI-Driven Search Engine on Visual Internet-of-Things”, which is incorporated herein by reference in its entirety.

### BACKGROUND

### Technical Field

This application relates to distributed deep learning systems and methods enabling real-time video scene parsing and indexing in the continuum of edge, EdgeCloud, and cloud backends. A distributed deep learning search platform taps into visual data collected using visual internet-of-things (VIoT) devices for parallel, real-time video-scene parsing while distributing the deep learning workload intelligently across VIoT devices, powerful EdgeCloud servers, and Cloud backends with adaptive data fusion algorithms. In particular, the system has applicability to applications in large-scale city wide search of events or individuals, disaster response management, traffic congestion management, weather updates, and more to enable smart and connected cities.

### Description of the Related Art

Video analytics is a technique to generate meaningful representation from raw data generated by cameras in the form of video and/or images. The demand for video analytics becomes more imperative in smart cities as they play a key role in a vast array of applications and fields such as urban structure planning, surveillance, forecasting, medical services, criminal investigation, advertising, and entertainment. Millions of connected devices, like connected cameras and streaming videos, are introduced to smart cities every year, which are a valuable source of information. Such valuable sources of information, however, are still left widely untapped. To understand useful information from such big data, machine learning (ML) and artificial intelligence (AI) approaches are often utilized for data analytics and have accomplished very promising results that can facilitate smart city development, which improves our quality of life. For instance, suppose an event happens and various types of evidence are being investigated. An intelligent video analytics system may be able to narrow the search based on various attributes and create a knowledge base that is more reliable and accurate for decision making and, subsequently, taking an action.

Video analytics is a resource-demanding procedure that requires massive computational clusters, advanced network configurations, and real-time data storage subsystems to deal with video streams captured from thousands of VIoT devices for event discovery. In a conventional video analytics pipeline, a camera video stream is processed live or as video recorded and analyzed retrospectively by trained operators. A manual analysis of the video streams recorded is a costly undertaking with an anticipated low return on the investment. This process is not only time consuming, but also requires a large amount of manpower and resources. Additionally, in many instances, a human operator may lose focus after a short time (e.g., 20 minutes), which may make it impossible to inspect live camera streams in a timely manner.

In real scenarios, an operator may have to inspect multi-camera live streams and recorded videos while tracking an object of interest, making things particularly worse when resources are scarce and relatively quick decisions need to be taken. To overcome these challenges, advanced video analytics focus on building a scalable and robust computer cluster for highly accurate automated analysis of video streams for object detection and action recognition. In these platforms, an operator will only define the attributes to be analyzed for detecting objects of interests; later, VIoT streams are automatically extracted, matched, analyzed, and finally fetched from internal storage to the dashboard provided for the investigation. The cloud servers with General Purpose Graphics Processing Units (GPGPUs) and VIoT devices with embedded graphics processing units (GPUs) could solve the latency challenge and enable video platforms to investigate video streams for real-time event-driven computing.

### BRIEF DESCRIPTION OF THE DRAWINGS

FIG. 1 illustrates a high-level architecture of a hierarchical scheme with query processing, EdgeCloud, and embedded AI and the description of corresponding latencies, according to some embodiments.

FIG. 2 illustrates a detailed hybrid analytics architecture with edge and cloud-based processing in different geographical zones, according to some embodiments.

FIG. 3 illustrates an object or person reidentification process using extracted embedding attribute matrices, according to some embodiments.

FIG. 4 illustrates an edge-cloud metadata caching and local metadata caching algorithm that utilizes multiple edge device metadata caches and a common (global) edge-cloud metadata cache for reidentification and matching, according to some embodiments.

FIG. 5 illustrates a detailed algorithm for multi-IoT content correlation through metadata matching and reidentification at edge-cloud, according to some embodiments.

FIG. 6 illustrates a local edge device metadata cache updating and correlation process, according to some embodiments.

FIG. 7 illustrates an edge-cloud server global metadata cache updating and correlation process, according to some embodiments.

FIG. 8 illustrates a hierarchical metadata generation using knowledge-graph by correlating objects and object attributes, according to some embodiments.

FIG. 9 illustrates examples of a metadata matrix and an adjacency matrix, according to some embodiments.

FIG. 10 is a block diagram of one embodiment of a computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION

Recent generations of VIoT surveillance camera systems provide seamless integration with edge computing and storage, thus enabling a very scalable edge analytics approach for surveillance and real-time analytics where the monitoring happens. The distributed edge systems reduce video processing overhead on the embedded devices. It also assists in balancing computing between both edge devices and cloud backend (Edge-to-Cloud). Therefore, developing a platform consisting of geo-distributed edge analytics is a promising realistic solution for the real-time at-scale VIoT analytics for the following reasons:
(i) Latency: human interaction or actuation of connected systems require videos to be processed at very low latency because the output of the analysis is to be used immediately;
(ii) Bandwidth: infeasibility in streaming a large number of high-resolution video feeds directly to the back-end servers as they require large bandwidth; and
(iii) Provisioning: utilizing computation close to the VIoT cameras allows for correspondingly lower provisioning (or usage) in the back-end servers.

Unlike existing platforms for at-scale video analytics, which use feature matching or symmetric and asymmetric comparisons, the system and methods introduced in the present disclosure deliver precise response actions by extracting, storing, and searching through large metadata databases generated, at different layers of the geo-distributed architecture, using AI algorithms. By intelligently distributing the AI workload over the edge and the cloud, the proposed architecture moves towards bridging the gap between the edge-to-cloud continuum.

The present disclosure describes the use of edge and cloud backends to synchronously work towards a set of goals. As such, significant benefits in distributing the compute over a set of edge, EdgeCloud, and cloud computing backends may be achieved. In order to facilitate the different activities done in the analytics pipeline, the disclosed architecture is based designing distributed machine learning cloud architectures for semantic analysis. The geo-distributed architecture may be designed based on zones and geo-tags. A geo-tag is assigned for each local area within a bigger zone. Each zone consists of multiple geo-tags. The geo-distributed embedded-AI cameras have unique id's that can help querying them with respect to zone and geo-tag information.

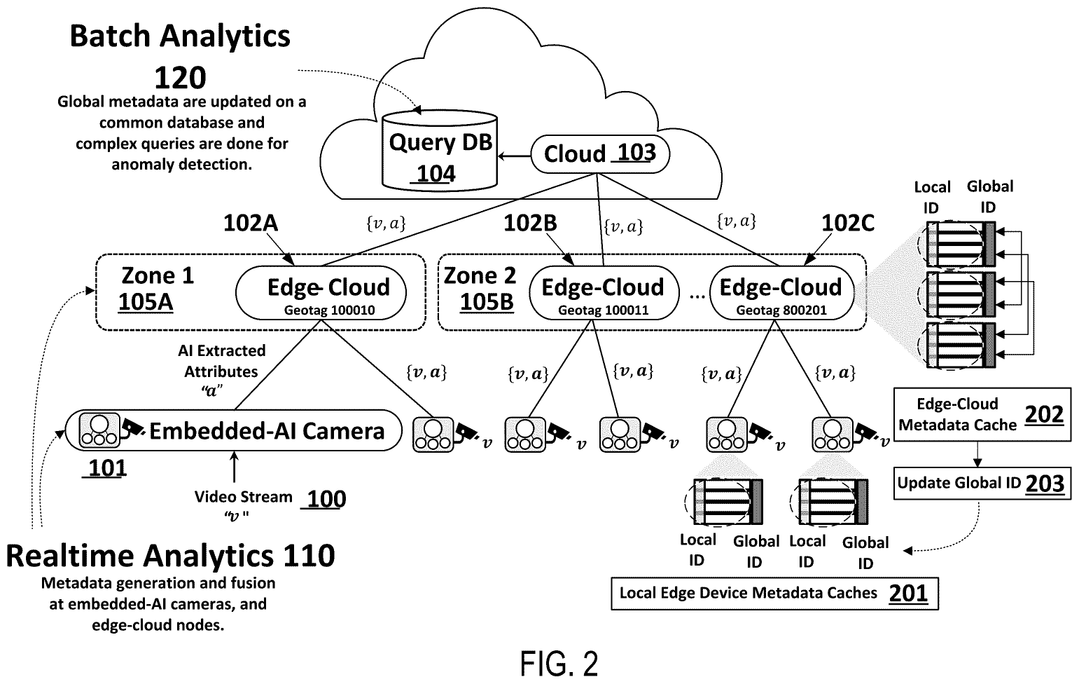

With this primary design, as illustrated in FIG. 2 and further described below, the general analytics pipeline are explained and the possibilities in distributing the AI workload over many layers of the architecture are explored. As such, the scheme involves embedded-AI edge devices extracting a set of attributes, EdgeCloud system fusing these attributes to make correlations for re-identification and anomaly detection, and cloud backend primarily used for large-scale metadata search for event discovery.

At the bottom layer, the disclosed scheme includes devices with embedded cameras streaming in visual information to be analyzed. Each VIoT device creates its own attribute metadata, which corresponds to the neural network algorithm used for inference. In some instances, these smart VIoT devices may be called “embedded-AI cameras”. Embedded-AI cameras may be considered as edge devices, unlike the traditional description of edge servers, to account for future upgradability. As such, an edge device is one which aggregates information from one or more sensors and processes these data. In this regard, the disclosed embedded-AI cameras are edge devices that support multiple input streams and run multiple neural network sessions to process them.

The intermediate EdgeCloud layer includes powerful compute nodes capable of running multiple AI applications concurrently with minimal latency. The layer may serve two main purposes: 1) fuse attributes from multiple VIoT devices and itself to generate a global metadata pool, and 2) extract attributes that induce higher latency that cannot be handled by the VIoT embedded devices. Technically, both embedded-AI devices and EdgeCloud devices could extract the same metadata according to the inference AI application. Once an anomaly is found, however, the system operator can switch to high-definition input sizes that, in most applications such as object detection and face recognition, saturate the compute available in embedded-AI devices. In these cases, EdgeCloud devices may be utilized to carry out real-time inference on the video stream on a per-frame basis by redirecting the video stream without processing them on embedded-AI cameras.

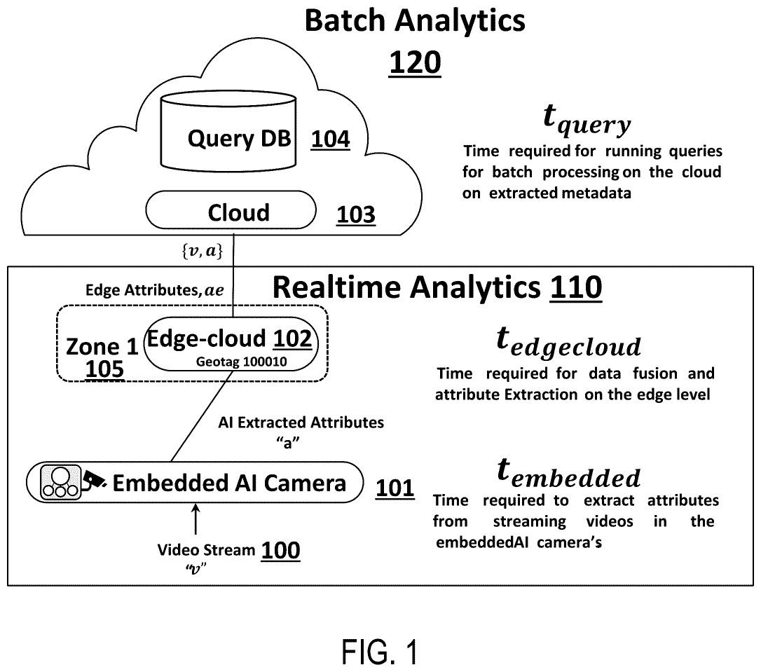

FIG. 1 illustrates a high-level architecture of a hierarchical scheme with query processing, EdgeCloud, and embedded AI and the description of corresponding latencies, according to some embodiments. In the illustrated embodiment, a distributed VIoT search platform, as described herein, takes a video input stream 100 to carry out real-time analytics 110 and batch analytics 120. In various embodiments, real-time analytics 110 includes real-time streaming analytics presented by embedded-AI IoT devices (e.g., an embedded AI camera 101) and edge-cloud (EdgeCloud) server 102 in zone 105 (e.g., zone 1). Batch analytics 120 includes batch processing in the cloud backend (e.g., could 103) where queries involving archived data can be reloaded and executed in compute intensive infrastructure (e.g., query database 104). In both real-time analytics 110 and batch analytics 120, the video analytics framework is evaluated by processing the video streams for detecting objects of interest, their actions, and attributes.

FIG. 2 illustrates a detailed hybrid analytics architecture with edge and cloud-based processing in different geographical zones, according to some embodiments. In the illustrated embodiment, each zone 105 (e.g., zone 1 105A, zone 2 105B, etc.) has many embedded-AI cameras 101 corresponding to edge-clouds 102 associated with the zones. Zones 105 may include one or more edge-cloud servers 102 in each zone. For instance, in the illustrated embodiment, zone 1 105A includes one edge-cloud server 102A and zone 2 105B includes 2 edge-cloud servers 102B, 102C.

In certain embodiments, edge-cloud servers 102 are categorized with unique geotags. The embedded-AI cameras 101 generate metadata based on AI algorithms and update local metadata caches associated with the cameras (e.g., local edge device metadata caches 201). Each local edge device metadata cache 201 has a local_{id} and a global_{id} associated with the cache and its metadata. Metadata replication, synchronization, reidentification of objects, and fusion of local metadata may proceed at edge-cloud servers 102. Metadata associated with edge-cloud servers may be stored in edge-cloud metadata cache 202. Storage of metadata may include storage of local_{id} and a global_{id} associated with each local edge device metadata cache 201.

As shown in FIG. 2, the hybrid analytics architecture may have a distributed nature of compute requirements that benefit from a continuum of metadata transmission. For instance, embedded-AI cameras 101 are distributed across different physical zones 105 of edge-cloud servers 102. These zones (e.g., zone 1 105A, zone 2 105B, etc.), as described above, may host edge-cloud servers 102. Edge-cloud servers 102 are compute intense severs that aggregate the video and available metadata from embedded-AI cameras 101.

In various embodiments, each edge-cloud server 102 is geo-distributed (such as in a city-scale environment). For instance, the geotags may correspond to zip codes (e.g., geotag 100010 for edge-cloud server 102A, geotag 100011 for edge-cloud server 102B, and geotag 800201 for edge-cloud server 102C are zip codes for the edge-cloud servers). Each zip code may be split into multiple geotags to host an edge-cloud server 102. Each zone 105 may host multiple such geotags. The video data that flows to edge-cloud server 102 and the metadata that are extracted in the edge-cloud server eventually streams to the cloud 103 at the backend. In certain embodiments, large queries may be run on the raw video data or the already extracted metadata by the use of powerful deep learning algorithms. The results are then saved in a database (e.g., query DB 104). Once the metadata is saved in the cloud, global access may be provided to query this large database for applications ranging from security, healthcare, traffic understanding, person identification, and more.

In various embodiments, compute needs are distributed to enable real-time processing of video and quick access to required metadata. Accordingly, metadata may be extracted from streaming video in each of embedded-AI edge cameras 101, edge-cloud servers 102, and cloud 103. The different metadata extracted may be combined in a time-synchronized way according to the information stored in the local edge device metadata caches 201, edge-cloud metadata cache 202, and the global metadata stored in cloud 103.

In some embodiments, the overall process of extraction and query may be simplified as followed: multiple video streams 100, V= {v₁, v₂, . . . , v_{c}} are captured by distributed embedded-AI edge cameras 101, where C is the number of cameras available. A user determines the region of interest in a video stream and selects a set of objectives, K= {k₁, k₂, . . . , kₖ}, for analysis. An analysis request, in the form of a query, is sent to the compute nodes in the required zone 105. This query may either be on real-time streaming feed or on saved offline feeds.

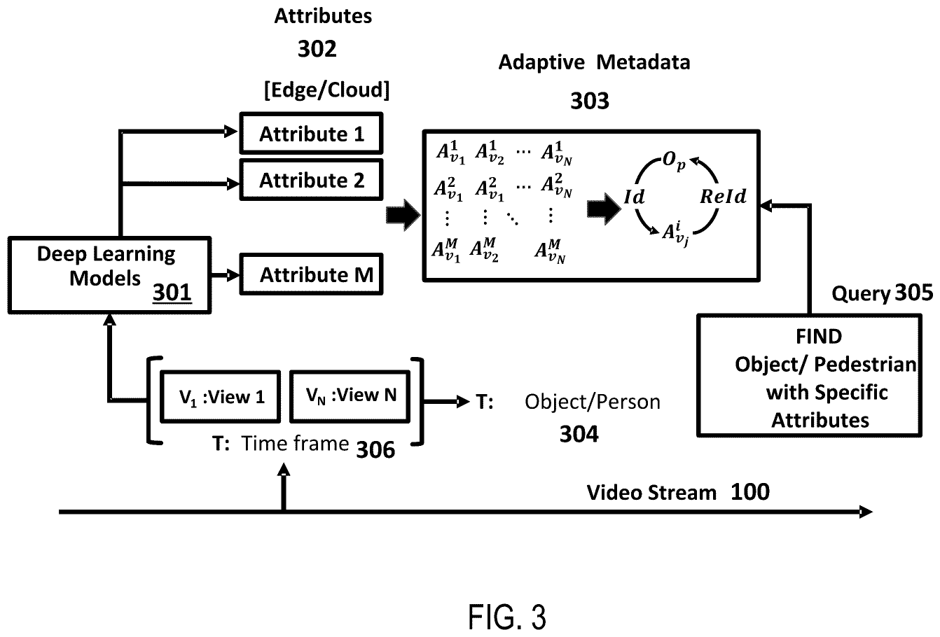

FIG. 3 illustrates an object or person reidentification process using extracted embedding attribute matrices, according to some embodiments. The objectives of the deep learning models 301, as illustrated in FIG. 3, could be to recognize faces, emotion, age, race, gender, and more of an individual, or to track an object or person over time, find actions, etc. For instance, in certain embodiments, deep learning models 301 may be implemented to recognize or track objects or persons 304 over time frame 306 (e.g., time frame between view 1 (V₁) and view N(Vₙ)) in a video stream 100. This process may be enabled with the help of deep analytics. Deep analytics may include mapping an input data space, X, into output metadata, Yₖ E {Y_{object}, Y_{attributes}} where k ∈K, by modeling it as a highly non-linear optimization problem [symbol] , where [symbol] are the learnable parameters of the function [symbol] . As such, the amount of intelligence injected to each device depends on the number of deep analytics solutions implemented and optimized for the device. Decisions regarding applications, attribute generation, input sizes, etc. are made according to configurations defined by a system administrator.

Rather than providing a set of hand-made input features to learn from, deep analytic solutions often find patterns in the input data itself. Output Yₖ for objective K and input v (k) now becomes:

$${Y}_{k} = ℱ ( v ( k ) , 𝒲 ( k ) ) .$$

Neural networks to generate these metadata can be trained by minimizing a differentiable loss function, thereby minimizing the error associated with learning the objective K. If N is the number of data samples of data D used to train an objective, a generic loss function for the optimization problem can be defined as:

$$min ℒ ( 𝒲 ) = \frac{1}{N} {\sum }_{i} {L}_{i} ( ℱ ( {v}_{i} , 𝒲 ) , {y}_{i} ) + λ {\sum }_{p} {\sum }_{q} {W}_{p , q}^{2} .$$

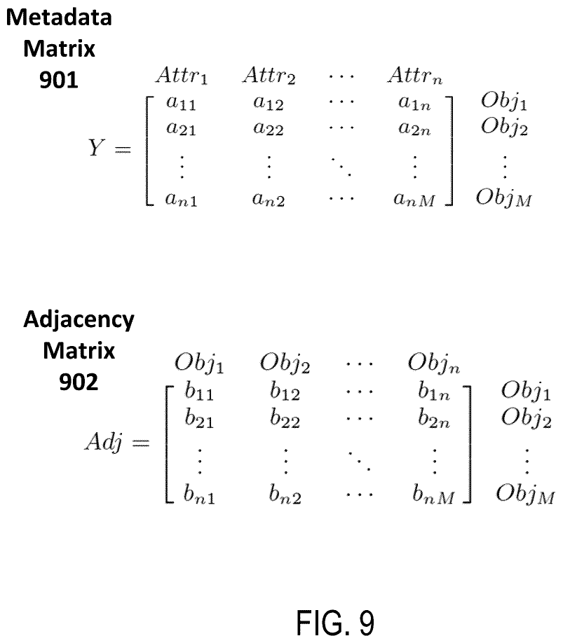

Metadata Y, corresponding to objective K, is supplementary information describing the data that an analytics solution works with. Identification of objects and people with a local_{id} is carried out. Y may be modelled as a labelled unidirectional graph, called adaptive metadata, based on examples of prior work with Y_{object} as vertices with recorded labels Y_{attributes}. This is represented as a matrix, where rows and columns represent objects and attributes respectively. As such, aᵢⱼ represents information related to j^{th} attribute of i^{th} object. FIG. 9 has an illustration of Y as metadata matrix 901.

An adjacency matrix, Adj, of size 0×0, may be calculated to represent the inter-object relationships, where O is the number of objects present in the current time-frame. Each element bᵢⱼ of the matrix could be modelled as adjᵢⱼ ∈B, where B={wearing, fighting, crying, . . . } represents an set of actions each objects Obj₁, Obj₂, etc. can be associated with. FIG. 9 has an illustration of Adj as adjacency matrix 902.

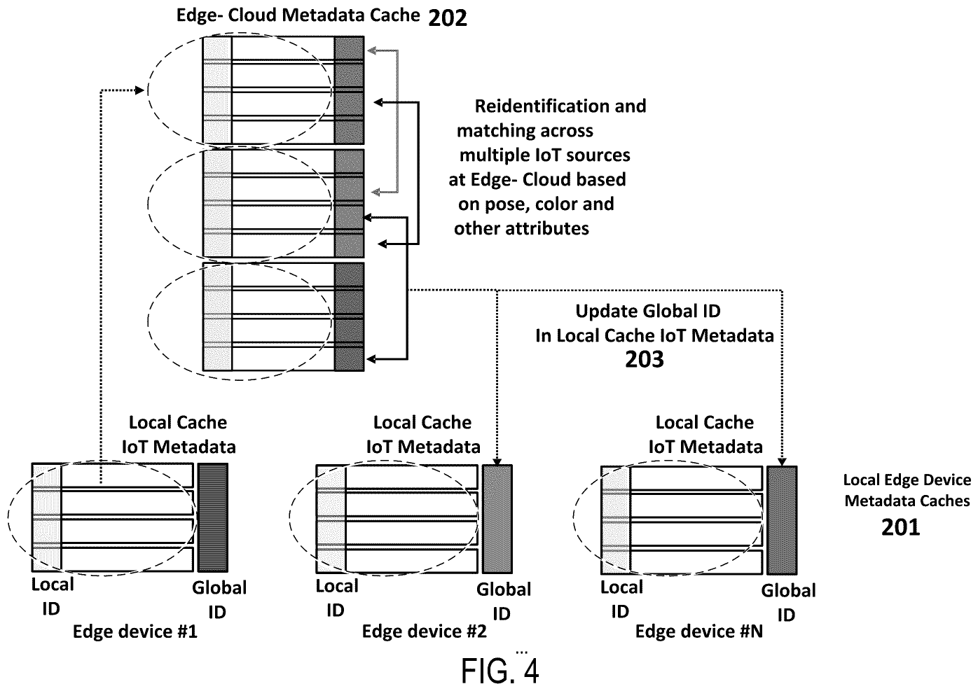

The generated graph and adjacency matrix may be stored in a local metadata cache (e.g., local edge device metadata cache 201) for later use. A global_{id} identifier also exists for the generated graph and adjacency matrix. The global_{id} identifier may get updated during further steps though the hierarchical pipeline (as shown at 203 in FIGS. 2 and 4). Together, the generated graph and adjacency matrix enables video analytics and creates security information and semantic maps from the visual data that is taken by video cameras (e.g., embedded-AI edge cameras 101).

Adaptive metadata Y^{z} (303 in FIG. 3) and related adjacency matrix Adj^{z} of corresponding zones 105, collected from a number of embedded-AI cameras 101, stream to the edge-cloud servers 102. In various embodiments, as shown in FIG. 2, a global cache (e.g., at edge-cloud metadata cache 202) is generated for edge-cloud servers 102 by correlating local_{id} (at local edge device metadata cache 201) of multiple Y^{z}˜∀z ∈Z. In some embodiments, reidentification and matching is done on the global cache and global_{id} is assigned/updated to each object.

FIG. 4 illustrates an edge-cloud metadata caching and local metadata caching algorithm that utilizes multiple edge device metadata caches and a common (global) edge-cloud metadata cache for reidentification and matching, according to some embodiments. In the illustrated embodiment, edge-cloud metadata cache 202 performs reidentification and matching across multiple local edge device metadata caches 201. In some embodiments, reidentification and matching is performed based on attributes in the objects. Attributes may include, for example, pose, color, and other attributes that define relationships between the persons or objects. The global_{id} identifier in local edge device metadata caches 201 may be updated based on the reidentification and matching, as shown at 203 in FIG. 4.

In certain embodiments, any unrecognized objects are identified and correlated during reidentification and matching. Thus, edge-cloud servers 102 carry out data fusion of multiple adaptive metadata streams to form a hierarchical adaptive metadata structure for robust anomaly detection, which might miss adversarial scenarios if done on only one stream of data. For example, concerns may be raised on events such as a person carrying a large backpack, analyzed and identified in one geotag, then reidentified in another geotag without the bag. This enables real time event-driven computing and optimizes the compute and network usage of embedded-AI devices (e.g., embedded-AI edge cameras 101) by promoting specific workloads, workload distribution, and result aggregation, thereby bridging the gap between the edge-cloud continuum.

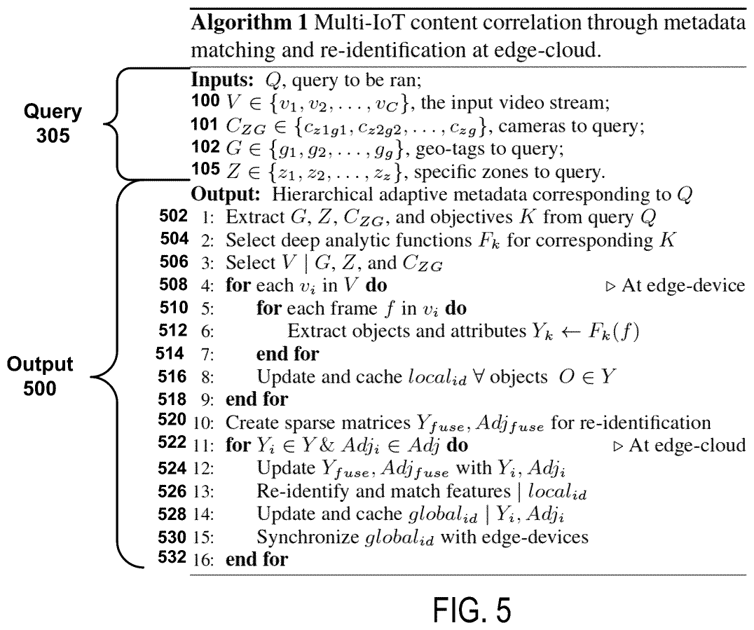

FIG. 5 illustrates a detailed algorithm for multi-IoT content correlation through metadata matching and reidentification at edge-cloud, according to some embodiments. In the illustrated embodiment, multi-IoT content correlation algorithm is explained in the context of object reidentification using deep neural networks in relation to the object or person reidentification process shown in FIG. 3. Thus, the various elements in the algorithm of FIG. 5 may be correlated to the elements in FIG. 3.

In various embodiments, each query 305, which may be sent by a user, contains information about cameras (e.g., embedded-AI edge cameras 101), geotags (corresponding to edge-cloud servers 102), and/or zones 105 to query for a particular video steam 100. Query 305 may also include information on objects/persons 304 and attributes 302 to implement for the query. Query 305 may also include time frame 306 over which to conduct the query. In various embodiments, output 500 is determined by extracting the information in query 305 to select machine learning (ML) algorithms for applying to data in the particular video stream 100. Then, for the particular video stream 100, the designated attributes 302 and objects/persons 304 may be extracted according to the ML algorithms associated with the various embedded-AI devices and edge-cloud servers to generate hierarchical adaptive metadata that corresponds to the information in query 305 as output 500.

Steps 502-532 are presented as one example embodiment for determining output 500 by extracting the information in query 305 and apply various ML algorithms to the data available for a particular video stream 100. It should be understood that various deviations from the depicted steps may be implemented according to knowledge of one skilled in the art while remaining within the scope of the present disclosure. Generating output 500 begins at 502 with extracting the information for geotags (G), zones 105 (Z), cameras 101 (C_{ZG}), and objectives (K). The objectives may include, as described herein, to recognize faces, emotion, age, race, gender, and more of an individual, or to track an object or person over time, find actions, etc. The objectives may be input by the user as part of query 305.

At 504, deep analytic functions (Fₖ) are selected for the corresponding objectives. Then at 506, the video stream (V) is selected based on the geotags, zones, and cameras. After this selection, in 508, each input (vᵢ) in the video stream, steps 510-516 are performed at the edge-device (e.g., cameras 101). Step 510 is for each frame (f) in the input (vᵢ), proceed at 512 with extracting objects and attributes where the output (Yₖ) corresponds to deep analytic functions on each frame (Fₖ(f)). At 514, steps 510 and 512 are ended and then at 516, the local_{id} for V objects at each local cache (e.g., local edge device metadata caches 201) are updated according to O E Y. This part of output 500 is ended at 518.

At 520, sparse matrices (Y_{fuse}, Adj_{fuse}) are created for reidentification. Then beginning at 522, edge-cloud servers 102 proceed with steps 524-530 for Yᵢ ∈Y & Adjᵢ ∈Adj. At 524, the sparse matrices (Y_{fuse}, Adj_{fuse}) are updated with the matrices (Yᵢ, Adjᵢ). Features are then reidentified and matched according to local_{id} at 526. At 528, the global_{id} is updated and cached (e.g., at edge-cloud metadata cache 202) based on the matrices (Yᵢ, Adjᵢ). At 530, global_{id} is synchronized with the edge-devices (e.g., cameras 101 and local edge device metadata caches 201). At 532, the generation of output 500 is ended.

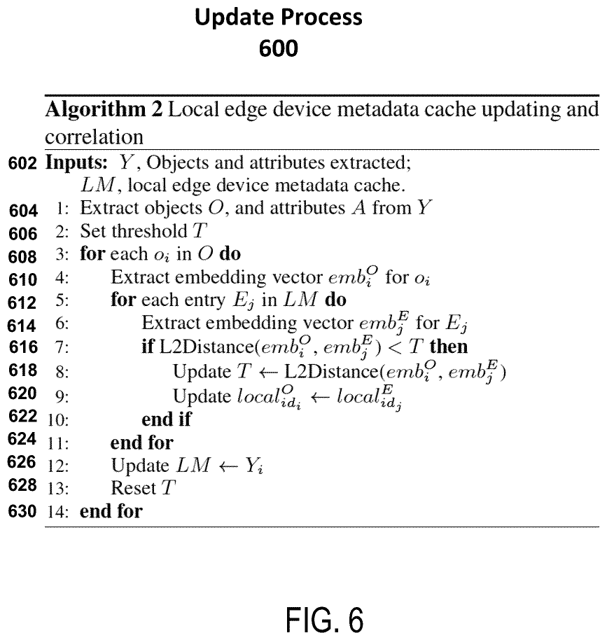

FIG. 6 illustrates a local edge device metadata cache updating and correlation process, according to some embodiments. The illustrated embodiment of update process 600 in FIG. 6 provides an example process for the updating that occurs at local edge device metadata caches 201 and may be part of the process of generating output 500. In various embodiments, update process 600 includes updating local edge device metadata caches 201 and determining correlations between local_{id} by finding the feature embeddings with lowest distances across the frames in a video.

In the illustrated embodiment, update process 600 begins at 602 with getting as inputs, the output (Y) along with the extracted objects and attributes. Then, for a local edge device metadata cache (LM), at 604, the objects (O) and attributes (A) are extracted from the output (Y). At 606, a threshold (T) is set. Then, beginning at 608 for each individual object (oᵢ) in the objects (O), steps 610-620 are performed. At 610, an embedding vector (embᵢ^{O}) is extracted for the individual object (oᵢ). At 612, for each entry (Eⱼ) in local edge device metadata cache (LM) (where an entry includes data copied into the cache and a memory location of the data), steps 614-620 are performed as follows. At 614, an embedding vector (embᵢ^{E}) is extracted for the entry. At 616, if the distance between embedding vector (embᵢ^{O}) and embedding vector (embᵢ^{E}) is less than the threshold (T), then the threshold is updated according to the distance between the embedding vectors and the local_{id} for the object is updated with the local_{id} for the entry. At 622, the process is ended if every entry has been processed. At 624, the process is ended if every individual object has been processed. At 626, the local edge device metadata cache (LM) based on the individual output (Yᵢ) and the threshold is reset at 628. Process 600 is then ended after all the local edge device metadata caches are updated at 630.

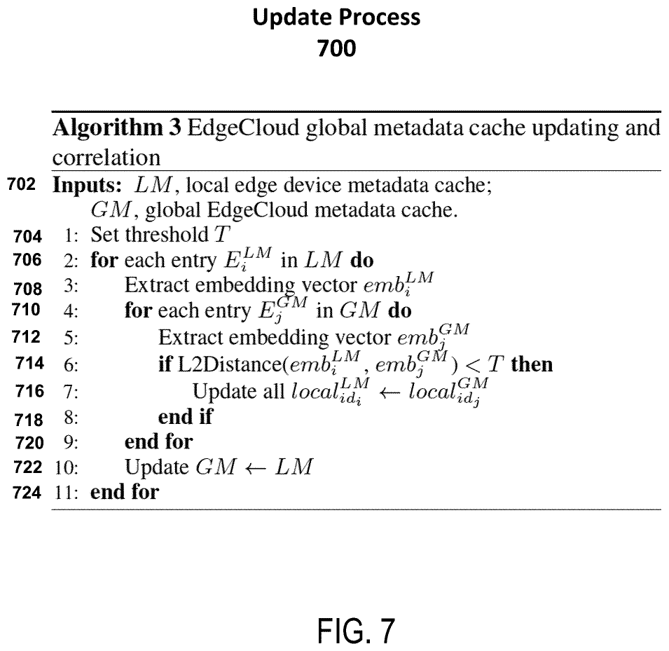

Adaptive metadata fusion may also happen at the level of edge-cloud servers 102 updating a global_{id} using logic similar to the logic shown in FIG. 6. For instance, the feature embeddings with minimal distances between global and local embeddings may be matched and updated using similar logic. FIG. 7 illustrates an edge-cloud server global metadata cache updating and correlation process, according to some embodiments. The illustrated embodiment of update process 700 in FIG. 7 provides an example process for the updating that occurs at edge-could metadata cache 202 and may be part of the process of generating output 500. In various embodiments, update process 700 includes updating edge-could metadata cache 202 and determining correlations between global_{id} by finding the feature embeddings with lowest distances across the frames in a video.

In the illustrated embodiment, update process 700 begins at 702 with getting as inputs, the local edge device metadata cache (LM) and the global edge-cloud metadata cache (GM). At 704, a threshold (T) is set. Then, at 706 for each entry (E/M) in the local edge device metadata cache (LM), an embedding vector (embᵢ^{LM}) is extracted at 708. Then, at 710 for each entry (Eᵢ^{GM}) in the global edge-cloud metadata cache (GM), an embedding vector (embᵢ^{GM}) is extracted at 712.

At 714, if the distance between embedding vector (embᵢ^{IM}) and embedding vector (embᵢ^{GM}) is less than the threshold (T), then all the local_{id} in the local edge device metadata cache (LM) are updated with the local_{id} found in the global edge-cloud metadata cache (GM) at 716. At 718, the process is ended if every entry in the global edge-cloud metadata cache (GM) has been processed. At 720, the process is ended if every entry in the local edge device metadata cache (LM) has been processed. At 722, the global edge-cloud metadata cache (GM) is updated according to the local edge device metadata cache (LM). Process 700 is then ended after all the global edge-cloud metadata cache (GM) is updated at 724.

As described above, both the local and global identifications (local_{id} and global_{id}) are updated in real-time (e.g., on the fly). Doing these updates in real-time provides significant performance improvements for the computational processes described herein that respond to the queries described herein. In various embodiments, once the objects and attributes that describe the object relationships are obtained, they can be correlated to a hierarchical knowledge-graph representation. For instance, the source node is an identifier to the image, with direct relations to objects and its attributes. Each object has multiple attributes, and each attribute might have further metadata associated with the attribute. Object and corresponding attribute nodes may be labelled with an action. Attributes to further metadata may be labelled with a fact.

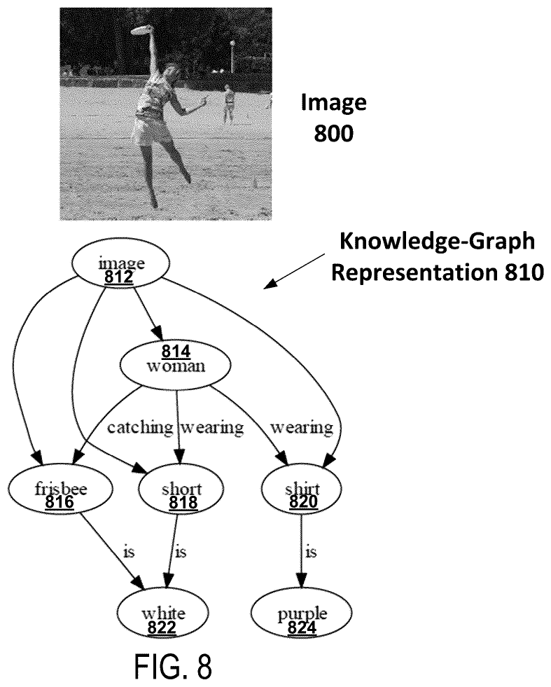

For instance, FIG. 8 illustrates a hierarchical metadata generation using knowledge-graph by correlating objects and object attributes, according to some embodiments. In the illustrated embodiment, an image 800 includes a woman catching a frisbee. A classification or prediction algorithm may implement the hierarchical metadata generation described herein to generate hierarchical knowledge-graph representation 810 of the image. Image 812, which identifies the image, is the source node. Additional nodes are generated that identify-woman 814, frisbee 816, short 818, shirt 820, white 822, and purple 824. Links are also generated between woman 814 and frisbee 816 (for catching), woman 814 and short 818 (for wearing), and woman 814 and shirt 820 (for wearing). White 822 and purple 824 are identifier nodes for colors of frisbee 816, short 818, and shirt 820 as characterized by the linking term “is” between the nodes.

Various algorithms, systems, and methods are presented in this disclosure that introduces a distributed video analytics query mechanism that involves swarms of small DNNs (deep neural networks) at embedded-AI edge devices (such as cameras), which can quickly perform initial feature detection and extraction (such as face or license plate preferable biometrics IDs), and also reidentification of features or objects in a cooperative manner. Then, the high-volume edge inference may fall back to a query computing model in the cloud, which performs complementary large scale-up processing and result generation. The final decision, labelling, and scene investigation may be done by humans after interpreting the query results. This approach can provide the benefit of low communication costs (edge to cloud) compared to continually offloading parallel streams of edge devices, such as video, to the cloud. Additionally, since a DNN embedding value of extracted features at the edge can be communicated instead of raw video streams (in unreliable low latency network segments), the described systems could provide better privacy safeguards and lower bandwidth requirements for cloud upload.

When considering event discovery time, despite its power, state-of-the-art centralized computing model such as cloud or high-performance computing (e.g., batch scale-up processing model) approaches are not best suitable for real-time cyber-physical hunting where operations are time-critical, and seconds or minutes can have disastrous consequences. The geographically distributed swarm-computing model at the edge described herein demonstrates up to 5× speedups where the feature discovery and inference are conducted at the edge by a swarm of cooperative edge embedded DNNs.

The disclosed embodiments present solutions that are more involved than simply utilizing deep learning algorithms on captured video surveillance in cloud servers. A geographically distributed swarm-computing model at the edge is particularly important when connected edge sensing devices carry out monitoring and anomaly event detection, where the latency between the decision making and edge devices should be at a minimum. In fact, the disclosed distributed edge-to-cloud computing hierarchy extends the computing power of cloud to the edge and builds a computing continuum paradigm for detecting and identifying the targeted object or event at the most logical and efficient spot.

Therefore, the disclosed distributed AI pipeline over edge-to-cloud computing hierarchies enables swarms of embedded AI sensors at the edge to geographically scale out objects and event detection (the most logical and efficient spot in the continuum between the data source and the cloud) while cloud analytics may be used complementary to scale up in-depth scene investigations for final decisions by humans. This makes the disclosed architecture fundamentally different from previous implementations. The disclosed embodiments are also different from some existing solutions in that the geo-distributed system of systems extracts metadata using deep learning algorithms in each compute layer and utilizes them as required in real-time while combining the results as the architecture goes higher to create much richer global metadata.

The present disclosure is also different from other crowd-sourcing based human-and-device query systems in that the query mechanism is based on the global metadata cache generated by summarizing the various local metadata available from a variety of geo-distributed cameras. A human decision-maker decides which objects to focus on and what attributes to extract. This way, disclosed algorithms provide granularity in terms of queries and may present the results through a web-interface using APIs (application programming interfaces). For instance, in some embodiments, an application programming interface (API) component operative on the cloud may be capable of receiving a query request from one or more geographically distributed zones to study object-attribute relationships across time. In some embodiments, an application programming interface (API) component is operative on the cloud to load custom deep learning models in each edge device (e.g., cameras 101) and edge-cloud device (e.g., edge-cloud servers 102).

### Example Computer System

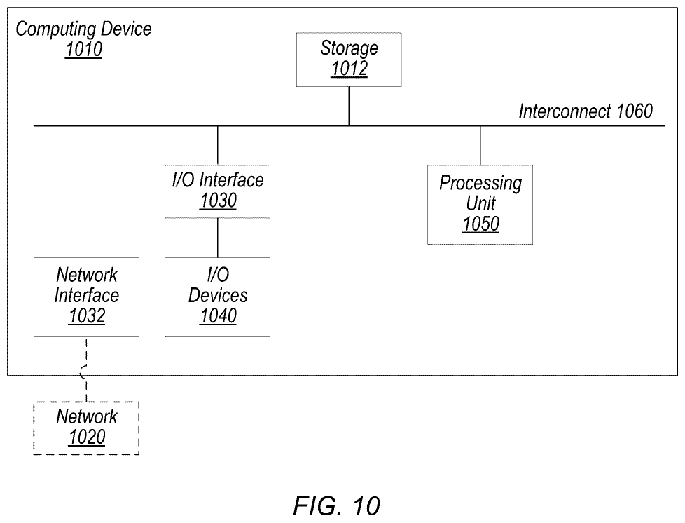

Turning now to FIG. 10, a block diagram of one embodiment of computing device (which may also be referred to as a computing system) 1010 is depicted. Computing device 1010 may be used to implement various portions of this disclosure. Computing device 1010 may be any suitable type of device, including, but not limited to, a personal computer system, desktop computer, laptop or notebook computer, mainframe computer system, web server, workstation, or network computer. As shown, computing device 1010 includes processing unit 1050, storage 1012, and input/output (I/O) interface 1030 coupled via an interconnect 1060 (e.g., a system bus). I/O interface 1030 may be coupled to one or more I/O devices 1040. Computing device 1010 further includes network interface 1032, which may be coupled to network 1020 for communications with, for example, other computing devices.

In various embodiments, processing unit 1050 includes one or more processors. In some embodiments, processing unit 1050 includes one or more coprocessor units. In some embodiments, multiple instances of processing unit 1050 may be coupled to interconnect 1060. Processing unit 1050 (or each processor within 1050) may contain a cache or other form of on-board memory. In some embodiments, processing unit 1050 may be implemented as a general-purpose processing unit, and in other embodiments it may be implemented as a special purpose processing unit (e.g., an ASIC). In general, computing device 1010 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage 1012 is usable by processing unit 1050 (e.g., to store instructions executable by and data used by processing unit 1050). Storage 1012 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage 1012 may consist solely of volatile memory, in one embodiment. Storage 1012 may store program instructions executable by computing device 1010 using processing unit 1050, including program instructions executable to cause computing device 1010 to implement the various techniques disclosed herein.

I/O interface 1030 may represent one or more interfaces and may be any of various types of interfaces configured to couple to and communicate with other devices, according to various embodiments. In one embodiment, I/O interface 1030 is a bridge chip from a front-side to one or more back-side buses. I/O interface 1030 may be coupled to one or more I/O devices 1040 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
capturing, by a plurality of geographically distributed embedded-AI (artificial intelligence) cameras, a set of streaming videos;
extracting, at the cameras, metadata information from the set of streaming videos using deep learning algorithms on the cameras to create local metadata;
storing the local metadata in local edge device metadata caches corresponding to the cameras;
providing the local metadata to one or more edge-cloud servers;
extracting, at the edge-cloud servers, additional metadata using deep learning algorithms on the edge-cloud servers;
combining the additional metadata with the local metadata to create global metadata;
storing the global metadata in an edge-cloud metadata cache;
providing the global metadata from the edge-cloud metadata cache to a cloud server;
extracting cloud metadata from the global metadata using deep learning algorithms on the cloud server;
updating the global metadata based on the cloud metadata; and
storing the updated global metadata in a query database.

2. The method of claim 1, wherein the edge-cloud servers are geographically distributed across one or more zones.

3. The method of claim 2, wherein the edge-cloud servers are geotagged according to geographical locations of the edge-cloud servers.

4. The method of claim 1, wherein the local metadata includes information describing objects and attributes in the set of streaming videos.

5. The method of claim 1, wherein the global metadata includes information describing objects and attributes in the set of streaming videos based on the local metadata.

6. The method of claim 1, further comprising implementing human-level querying of the query database for geographically distributed queries based on identification of specific objects and attributes of interest in the set of streaming videos.

7. The method of claim 6, further comprising implementing the querying by video stream content correlation through metadata matching and reidentification at the edge-cloud metadata cache.

8. The method of claim 6, further comprising implementing a classification algorithm to generate a hierarchical knowledge-graph representation of one or more images in the set of streaming videos.

9. The method of claim 1, further comprising implementing updating for the local metadata on the local edge device metadata caches based on distance correlations between objects and entries in the local edge device metadata caches.

10. The method of claim 9, wherein the local metadata includes local identifiers and global identifiers for objects and attributes in the local metadata, and wherein the updating includes updating the local identifiers.

11. The method of claim 1, further comprising implementing updating for the global metadata on the edge-cloud metadata cache based on distance correlations between entries in the local edge device metadata caches and entries in the edge-cloud metadata cache.

12. The method of claim 11, wherein the global metadata includes local identifiers and global identifiers for objects and attributes in the global metadata, and wherein the updating includes updating the global identifiers.

13. A geographically distributed computer system, comprising:
a plurality of geographically distributed embedded-AI (artificial intelligence) cameras, the cameras having a non-transitory memory and a processor coupled to the non-transitory memory and configured to read instructions from the non-transitory memory to cause the cameras to:
capture a set of streaming videos;
extract metadata information from the set of streaming videos using deep learning algorithms to create local metadata; and
store the local metadata in a plurality of local edge device metadata caches;
one or more geographically distributed edge-cloud servers coupled to the cameras and the local edge device metadata caches, the edge-cloud servers having non-transitory memory and processors coupled to the non-transitory memory and configured to read instructions from the non-transitory memory to cause the edge-cloud servers to:
extract additional metadata using deep learning algorithms;
combine the additional metadata with the local metadata to create global metadata; and
store the global metadata in an edge-cloud metadata cache;
a cloud server having non-transitory memory and one or more processors coupled to the non-transitory memory and configured to read instructions from the non-transitory memory to cause the cloud server to:
extract cloud metadata from the global metadata using deep learning algorithms on the cloud server;
update the global metadata based on the cloud metadata; and
store the updated global metadata in a query database.
